(19) United States
(12) Patent Application Publication
(10) Pub. No.: US 2008/0177852 A1
(43) Pub. Date: Jul. 24, 2008

(54) Systems, Methods, and Media for Sharing Input Device Movement Information in an Instant Messaging System

(76) Inventors: Yen-Fu Chen, Austin, TX (US); John Hans Handy-Bosma, Cedar Park, TX (US); Mei Yang Selvage, Pocatello, ID (US); Keith Raymond Walker, Austin, TX (US)

Correspondence Address: IBM CORPORATION (JSS);C/O SCHUBERT OSTERRIEDER & NICKELSON PLLC, 6013 CANNON MOUNTAIN DRIVE, S14, AUSTIN, TX, 78749, US

(21) Appl. No.: 12/058,645

(22) Filed: Mar. 28, 2008

Related U.S. Application Data
(63) Continuation of application No. 11/260,564, filed on Oct. 27, 2005.

(51) Int. Cl. G06F 15/16

(52) U.S. Cl. 709/206

(57) ABSTRACT

Systems, methods and media for sharing input device movement information between users of an instant messaging system on a network by facilitating transmission and display to one user input device movement information from another user are disclosed. Embodiments may include receiving tracking information by a first client computer system where the tracking information relates to input device movement associated with a second client computer system. Embodiments may also include determining an equivalent movement based on the received tracking information and displaying the equivalent movement by the first client computer system. Tracking information may include one or more of a beginning or ending point for highlighting, a beginning or ending point for pointer movement, or an indication of velocity or emphasis. Displaying the equivalent movement may include displaying a moving ghost pointer or highlighting at the first client computer system.

### CROSS-REFERENCES TO RELATED APPLICATIONS

Pursuant to 35 USC § 120, this continuation application claims priority to and benefit of U.S. patent application Ser. No. 11/260,564, entitled “SYSTEMS, METHODS, AND MEDIA FOR SHARING INPUT DEVICE MOVEMENT INFORMATION IN AN INSTANT MESSAGING SYSTEM”, attorney docket number AUS920050628US1(4136), filed on Oct. 27, 2005, the disclosure of which is incorporated herein in its entirety for all purposes.

### FIELD OF INVENTION

The present invention is in the field of data processing systems and, in particular, to systems, methods and media for sharing input device movement information between users of an instant messaging system on a network by facilitating transmission and display to one user input device movement information from another user.

### BACKGROUND

Personal computer systems are well known in the art. They have attained widespread use for providing computer power to many segments of today's modern society. Personal computers (PCs) may be defined as a desktop, floor standing, or portable microcomputer that includes a system unit having a central processing unit (CPU) and associated volatile and non-volatile memory, including random access memory (RAM) and basic input/output system read only memory (BIOS ROM), a system monitor, a keyboard, one or more flexible diskette drives, a CD-ROM or DVD-ROM drive, a fixed disk storage drive (also known as a “hard drive”), a pointing device such as a mouse, and an optional network interface adapter. One of the distinguishing characteristics of these systems is the use of a motherboard or system planar to electrically connect these components together. The use of mobile computing devices, such as notebook PCs, personal digital assistants (PDAs), sophisticated wireless phones, etc., has also become widespread. Mobile computing devices typically exchange some functionality or performance when compared to traditional PCs in exchange for smaller size, portable power, and mobility.

The widespread use of PCs and mobile computing devices in various segments of society has resulted in a reliance on computer systems both at work and at home, such as for telecommuting, news, stock market information and trading, banking, shopping, shipping, communication in the form of hypertext transfer protocol (http) and e-mail, as well as other services. Many of these functions take advantage of the communication abilities offered by the Internet or other networks, such as local area networks.

A computer system application that continues to increase in popularity is instant messaging (IM). IM systems allow two or more users on computer systems such as PCs or mobile computing devices to exchange messages in real-time (or near real-time). IM systems allow users to maintain a list of other users, called a buddy or contact list, with whom they wish to interact. Using the IM system, a user can send an instant message to any person on their contact list as long as that person is on-line. Sending a message to an on-line user opens up an instant messaging window where each user may type messages that the other user may see, allowing for an electronic “conversation”. The instant messaging window typically includes both text input by the user as well as received messages, with new content typically appearing at the bottom of the window as older content scrolls upwards in the window. Many IM systems also provide chat room capability, where a user can set up a chat room to be shared by multiple users. The chat room operates under the same principles as basic instant messaging applied to multiple users, as each user may type in messages for other users in the chat room to see. Existing IM systems include Time Warner, Inc.'s AOL® Instant Messenger™ (AIM), Microsoft® Corporation's MSN Messenger™, and Yahoo! Inc.'s Yahoo!® Messenger™.

The popularity of IM systems is partially based on the immediacy of IM systems, particularly when compared to e-mail. This immediacy typically requires both parties in an IM exchange to be on-line at the same time, in contrast to e-mail. It allows, however, for interactive, back-and-forth exchanges of information without having to perform multiple steps to read, reply, and send a reply e-mail. By ensuring that the recipient of a message is available when a message is sent, the message can be delivered and presented to the recipient nearly instantly (as network conditions allow).

IM systems allow users to exchange text messages as well as files such as sounds, video, or pictures. Existing IM systems, however, do not provide an efficient and effective mechanism for a user to share gestures or other types of inputs with other IM system users. A user desiring to point out a word, sentence or earlier part of the “conversation”, for example, must describe the earlier text using a written description, such as by referring to the text “five lines back” or “a few paragraphs ago”. Such a methodology can be imprecise and time-consuming and its problems can be exacerbated when users have different sized windows, fonts, screen resolutions, etc. Another solution to this problem would be a remote control system allowing one user to control a pointer on a second system, but such as solution is inefficient and intrusive. There is, therefore, a need for an easy and effective system to facilitate sharing gestures or other types of inputs with other IM system users on an IM system.

### SUMMARY OF THE INVENTION

The problems identified above are in large part addressed by systems, methods and media for sharing input device movement information between users of an instant messaging system on a network by facilitating transmission and display to one user input device movement information from another user. Embodiments may include a method for receiving tracking information by a first client computer system where the tracking information relates to input device movement associated with a second client computer system. The method may also include determining an equivalent movement based on the received tracking information and displaying the equivalent movement by the first client computer system. Tracking information may include one or more of a beginning or ending point for highlighting, a beginning or ending point for cursor movement, or an indication of velocity or emphasis. Displaying the equivalent movement may include displaying a moving ghost cursor or highlighting at the first client computer system.

Another embodiment provides a machine-accessible medium containing instructions effective, when executing in a data processing system, to cause the system to perform a series of operations for sharing input device movement information between users of an instant messaging system on a network. The series of operations generally includes receiving tracking information by a first client computer system where the tracking information relates to input device movement associated with a second client computer system. The series of operations may also include determining an equivalent movement based on the received tracking information and displaying the equivalent movement by the first client computer system.

A further embodiment provides a client computer system of an instant messaging system. The client computer system may include an instant messaging client to initiate an instant messaging session with a second client computer system and to send and receive instant messages. The client computer system may also include a communications module to receive tracking information over a network, where the tracking information relates to input device movement associated with the second client computer system. The client computer system may further include an input device movement translator to translate the received tracking information to an equivalent movement for display to a user.

### BRIEF DESCRIPTION OF THE DRAWINGS

Other objects and advantages of the invention will become apparent upon reading the following detailed description and upon reference to the accompanying drawings in which, like references may indicate similar elements:

FIG. 1 depicts an environment for an instant messaging system for sharing input device movement information between users of an instant messaging system according to one embodiment;

FIG. 2 depicts a block diagram of one embodiment of a computer system suitable for use as a component of the IM system;

FIG. 3 depicts a conceptual illustration of software components of a client computer system of the instant messaging system according to one embodiment;

FIG. 4 depicts an example of a flow chart for determining and transmitting tracking information relating to input device movement according to one embodiment;

FIG. 5 depicts an example of a flow chart for receiving highlighting tracking information from another client computer system and displaying an equivalent movement to a user according to one embodiment; and

FIG. 6 depicts an example of a flow chart for receiving pointer movement tracking information from another client computer system and displaying an equivalent movement to a user according to one embodiment.

### DETAILED DESCRIPTION OF EMBODIMENTS

The following is a detailed description of example embodiments of the invention depicted in the accompanying drawings. The example embodiments are in such detail as to clearly communicate the invention. However, the amount of detail offered is not intended to limit the anticipated variations of embodiments; on the contrary, the intention is to cover all modifications, equivalents, and alternatives falling within the spirit and scope of the present invention as defined by the appended claims. The descriptions below are designed to make such embodiments obvious to a person of ordinary skill in the art.

Generally speaking, systems, methods and media for sharing input device movement information between users of an instant messaging system on a network by facilitating transmission and display to one user input device movement information from another user are disclosed. Embodiments may include receiving tracking information by a first client computer system where the tracking information relates to input device movement associated with a second client computer system. Embodiments may also include determining an equivalent movement based on the received tracking information and displaying the equivalent movement by the first client computer system. Tracking information may include one or more of a beginning or ending point for highlighting, a beginning or ending point for pointer movement, or an indication of velocity or emphasis. Displaying the equivalent movement may include displaying a moving ghost pointer or highlighting at the first client computer system.

The system and methodology of the disclosed embodiments allows users to share input device information, such as highlighting of text or pointer movements, between instant messaging clients on different computer systems. Using the disclosed system, a user may thus highlight text or use pointer gestures to communicate information, such as by indicating a relationship between two lines of instant messaging text. Other users in the instant messaging session may see an equivalent movement in their instant messaging window. The disclosed system may thus provide for an effective and efficient way of communicating information during an instant messaging session.

While specific embodiments will be described below with reference to particular configurations of hardware and/or software, those of skill in the art will realize that embodiments of the present invention may advantageously be implemented with other substantially equivalent hardware and/or software systems. Aspects of the invention described herein may be stored or distributed on computer-readable media, including magnetic and optically readable and removable computer disks, as well as distributed electronically over the Internet or over other networks, including wireless networks. Data structures and transmission of data (including wireless transmission) particular to aspects of the invention are also encompassed within the scope of the invention.

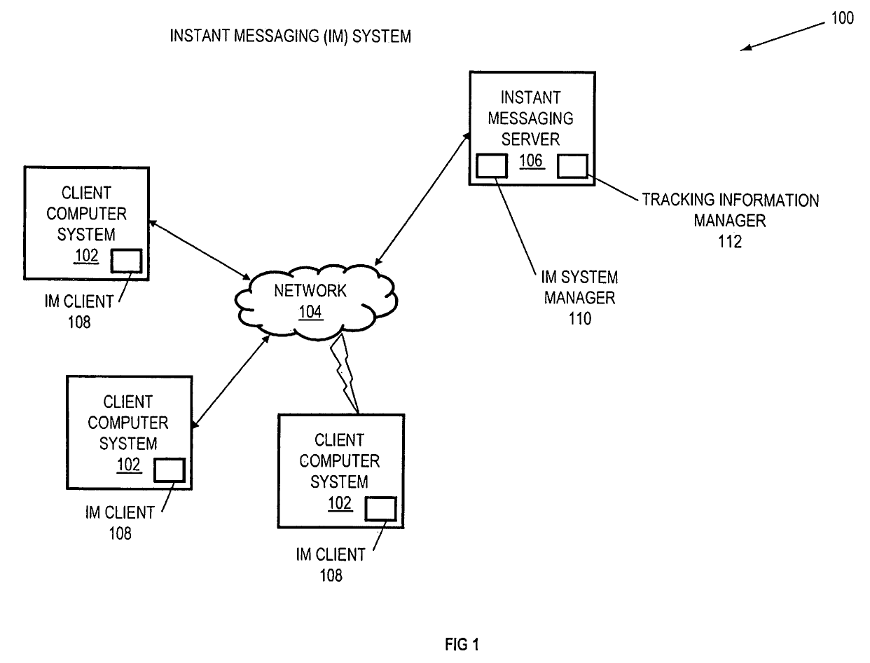

Turning now to the drawings, FIG. 1 depicts an environment for an instant messaging system for sharing input device movement information between users of an instant messaging system according to one embodiment. In the depicted embodiment, the instant messaging (IM) system 100 includes a plurality of client computer systems 102 in communication with a network 104. The IM system 100 may also include an IM server 106 in communication with network 104 for managing the instant messaging system. In the IM system 100, the client computer systems 102 and the IM server 106 may be located at the same location, such as in the same building or computer lab, or could be remote. While the term “remote” is used with reference to the distance between the components of the IM system 100, the term is used in the sense of indicating separation of some sort, rather than in the sense of indicating a large physical distance between the systems. For example, any of the components of the IM system 100 may be physically adjacent or located as part of the same computer system in some network arrangements.

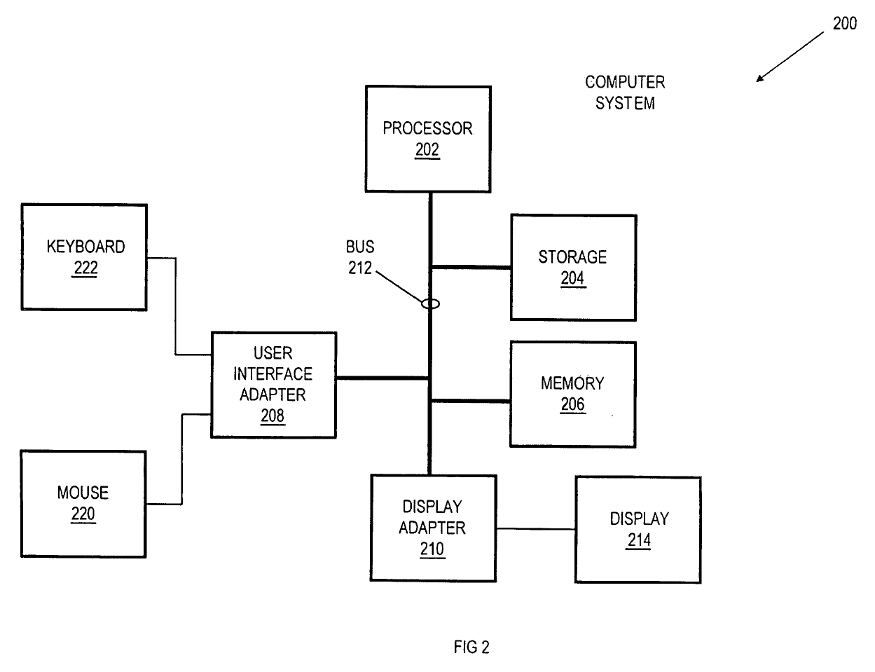

Client computer system 102 may include one or more personal computers, workstations, servers, mainframe computers, notebook or laptop computers, desktop computers, PDAs, set-top boxes, mobile phones, wireless devices, or the like. In some embodiments, client computer system 102 may be a computer system as described in relation to FIG. 2. The client computer system 102 may be in wired or wireless communication with network 104. Each client computer system 102 may include an IM client 108, which may be a software application that communicates with the IM server 106 to facilitate instant messaging by a user of the client computer system 102 with another user. In this embodiment, the IM client 108 may transmit information, such as messaging content or input device movement information, to the IM server 106, which in turn may forward it to a recipient client computer system 102. The IM client 108 may receive information as well, such as messaging content or tracking information, from the IM server 106. Alternatively, the IM clients 108 of different client computer systems 102 may communicate with each other directly instead of communicating through the IM server 106.

Network 104 may be any type of data communications channel, such as the Internet, an intranet, a LAN, a WAN, an Ethernet network, a wireless network, a proprietary network, or a broadband cable network. Many instant messaging systems, such as ICQ, utilize the Internet and are open to all. Other IM systems, such as AIM™, use proprietary networks, while others such as MSN Messenger™ use semi-private networks. Those skilled in the art will recognize, however, that the invention described herein may be implemented utilizing any type of data communications channel.

The IM server 108 may be executing on one or more personal computers, workstations, servers, mainframe computers, notebook or laptop computers, desktop computers, or the like. In some embodiment, the IM server 108 may be a computer system as described in relation to FIG. 2. An example IM server 108 is an International Business Machine Corporation (IBM) eServer® server. In one embodiment, the IM server 106 may include an IM system manager 110 to facilitate instant messaging between IM clients 108 on different client computer systems 102 by transmitting and receiving information, such as the identification, status, and/or network address of IM clients 108 and/or client computer systems 102, messaging content, or information relating to movement of user input devices. Many different IM system manager 110 applications exist, such as ICQ, AIM™, MSN Messenger™, Yahoo!® Messenger™, Jabber, etc. The IM server 106 may also optionally include a tracking information manager 112. The tracking information manager 112 may receive, transmit, and/or analyze tracking information. For example, the tracking information manager 112 may receive tracking information from a sending IM client 108, optionally analyze or otherwise process it, and then transmit the tracking information to a recipient IM client 108. A tracking information manager 112 may not be needed if, for example, the tracking information is handled in the same fashion as messaging content or if two client computer systems 102 are in direct communication without the IM server 106 being involved.

The system and methodology of the disclosed embodiments allows two users utilizing IM clients 108 on different client computer systems 102 to share input device movements between them. In one embodiment, a user of a client computer system 102 may initiate an instant messaging conversation with another user utilizing an IM client 108 on a different client computer system 102. The client computer system 102 may (such as upon request of the user) receive user input from a user input device representing movement of a pointer or other representation of the input device in the instant messaging window of that user's IM client 108. The user may, for example, point out text from a few lines back in the history with a gesture of their mouse or highlight earlier text with the mouse. The client computer system 102 may then convert that input into tracking information for transmission and use by a recipient client computer system 102. The recipient client computer system 102 may then use the tracking information to determine an equivalent movement for the open window of its IM client 108 and then to display that equivalent movement to the user in the instant messaging window. If the first user highlighted text with her mouse, for example, the same text would be highlighted in the instant messaging window for the second user. In another example, if the first user used their mouse to circle a word or point to a portion of the window, such gesture or motion would be repeated in the second user's window. In this way, users may effectively communicate gestures or other movement between them utilizing instant messaging windows without having to use remote control system or to laboriously describe what sort of motion they are making. A user may simply highlight or point her mouse towards particular text in the instant messaging window and have an equivalent motion be performed for the person with whom they are communicating.

FIG. 2 depicts a block diagram of one embodiment of a computer system 200 suitable for use as a component of the IM system 100, such as a client computer system 102 or an IM server 106. Other possibilities for the computer system 200 are possible, including a computer having capabilities other than those ascribed herein and possibly beyond those capabilities, and they may, in other embodiments, be any combination of processing devices such as workstations, servers, mainframe computers, notebook or laptop computers, desktop computers, PDAs, mobile phones, wireless devices, set-top boxes, or the like. At least certain of the components of computer system 200 may be mounted on a multi-layer planar or motherboard (which may itself be mounted on the chassis) to provide a means for electrically interconnecting the components of the computer system 200.

In the depicted embodiment, the computer system 200 includes a processor 202, storage 204, memory 206, a user interface adapter 208, and a display adapter 210 connected to a bus 214. The bus 214 facilitates communication between the processor 202 and other components of the computer system 200, as well as communication between components. Processor 202 may include one or more system central processing units (CPUs) or processors to execute instructions, such as an IBM® PowerPC™ processor, an Intel Pentium® processor, an Advanced Micro Devices Inc. processor or any other suitable processor. The processor 202 may utilize storage 204, which may be non-volatile storage such as one or more hard drives, tape drives, diskette drives, CD-ROM drive, DVD-ROM drive, or the like. The processor 202 may also be connected to memory 206 via bus 212, such as via a memory controller hub (MCH). System memory 206 may include volatile memory such as random access memory (RAM) or double data rate (DDR) synchronous dynamic random access memory (SDRAM).

The user interface adapter 208 may connect the processor 202 with user interface devices such as a mouse 220 or keyboard 222. The user interface adapter 208 may also connect with other types of user input devices, such as touch pads, touch sensitive screens, electronic pens, microphones, etc. The bus 212 may also connect the processor 202 to a display, such as an LCD display or CRT monitor, via the display adapter 210.

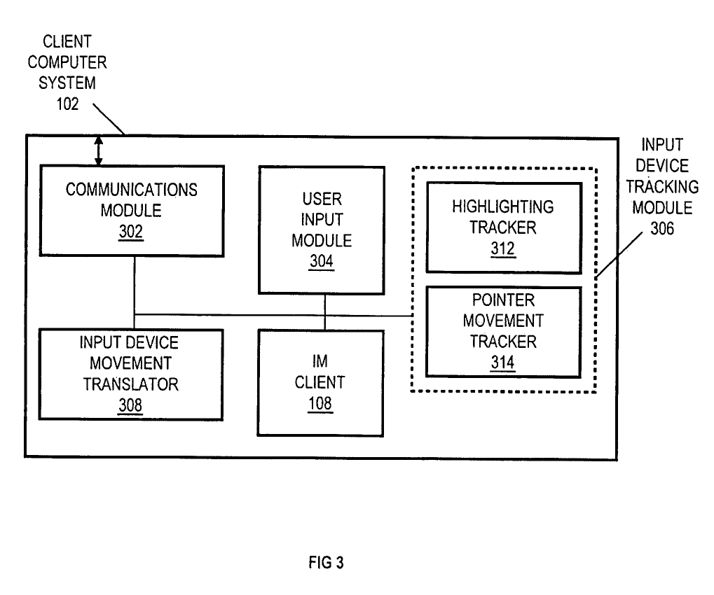

FIG. 3 depicts a conceptual illustration of software components of a client computer system of the instant messaging system according to one embodiment. The client computer system 102 of the depicted embodiment includes an IM client 108, a communications module 302, a user input module 304, an input device tracking module 306, and an input device movement translator 308. The IM client 108 may initiate IM sessions, receive and transmit user authentication information (i.e., password and ID), provide for the transmission and receipt of messaging content during the session, maintain contact lists of other users associated with other IM clients 108, encrypt or decrypt communications, or perform other tasks associated with instant messaging. The IM client 108 may utilize the communications module 302 to facilitate communications to and from an IM server 106 and/or the IM clients 108 of other client computer systems 102 via network 104. The user input module 304 may receive user input from user input devices such as a mouse 220 or keyboard 222 and may transmit an indication of the received input to other components of the client computer system 102, such as the input device tracking module 306.

The input device tracking module 306 may determine that the movement of an input device should be tracked and may also track the input device movement signals received by the user input module 304. The input device tracking module 306 may determine that the input device movement should be tracked in any fashion. In one embodiment, the input device tracking module 306 may determine to track the movement in response to receiving a request from a user via the user input module 304 to do so. For example, the client computer system 102 may be configured such that actuation of the ‘right’ mouse-button acts as a request by the user for movement of the mouse 220 to be tracked while the button is held down (or, alternatively, to the next actuation). In another example, pressing a key of the keyboard 222 (e.g., the CNTL-key) may also serve as a user request to tracking of pointer movement resulting from use of a mouse 220. In alternative embodiments, the input device tracking module 306 may determine that the input device movement should be tracked based on an administrator request, automatically, upon the occurrence of a particular event or condition, or any other criteria. Once input device movement tracking is initiated, the input device tracking module 306 (through the use of its sub-modules, described subsequently) may determine tracking information based on the received input device movement information for transmission to another client computer system 102 and/or IM client 108.

The input device tracking module 306 may include one or more sub-modules to track the input device movement and to determine tracking information based on the movement. In the disclosed embodiment, the input device tracking module 306 includes a highlighting tracker sub-module 312 and a pointer movement tracker sub-module 314. The highlighting tracker sub-module 312 may track highlighting of text by a user in an instant messaging window. In some embodiments, a user may highlight text by actuating and holding the left-mouse button of their mouse 220 and using the mouse 220 to ‘drag’ over the text to be highlighted. When a user highlights text in their IM window, the highlighting tracking sub-module 312 may, in one embodiment, track such a movement by determining the first and last characters that are highlighted (with all characters in between the first and last characters also being highlighted). The tracking information in this environment may be the location or identity of the first and last highlighted characters (e.g., from the 5^{th} character to the 37^{th} character), as well as additional information about the highlighting such as a special emphasis (e.g., different color, font, size, etc.). As will be described in more detail subsequently, another client computer system 102 according to the disclosed system may receive the tracking information and display an indication of that highlighting in its own IM window, thus allowing the users to share the highlighting information. A user may utilize other methodologies to highlight text, such as by double-clicking a mouse button to highlight a word, triple-clicking a mouse button to highlight a sentence or paragraph, holding down a key on the keyboard 222 while moving the mouse 220, etc. These alternative methodologies may also be used to provide different types of emphasized highlighting (e.g., triple-clicking a word to show highlighting in a different color).

The pointer movement tracker sub-module 314 may track mouse movement by a user in an instant messaging window to determine tracking information for use by another client computer system 102 and/or IM client 108. In some embodiments, a user may move the mouse 220 or other pointing device (e.g., a finger on a touch-screen display, a joystick, a trackball, voice commands, etc.) to cause gestures of a pointer in the instant messaging window. For example, a user may use the mouse 220 to point to a word with the pointer, point to a block of text, emphasize a portion of their open window, gesture a connection between two chat lines, move the pointer back and forth over a word or group of words, or otherwise try to communicate with movement of the pointer. As will be described in more detail subsequently, the pointer movement tracker sub-module 314 may receive these input device movements and determine tracking information based on them for use by another client computer system 102 and/or IM client 108. In some embodiments, the pointer movement tracker sub-module 314 may determine the tracking information by determining the beginning and end characters of a movement (and optionally the speed of that movement). The pointer movement tracker sub-module 314 may use any methodology to determine tracking information based on pointer movement. One skilled in the art will recognize that the input device tracking module 306 may contain other sub-modules for tracking other types of movement, such as movement by a joystick, key presses on a keyboard 220, actuation of different mouse 220 buttons, or movement of a finger on a touch-screen display.

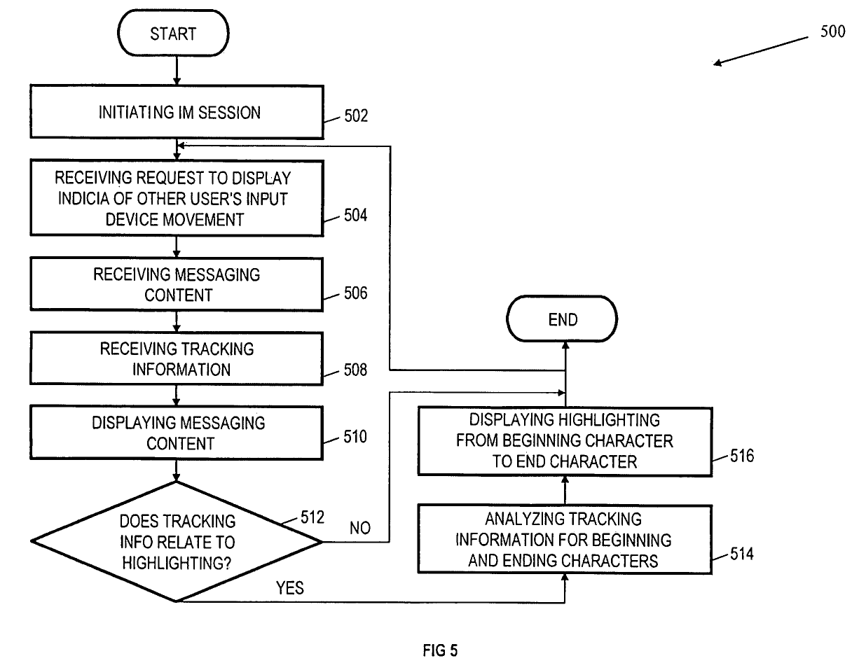

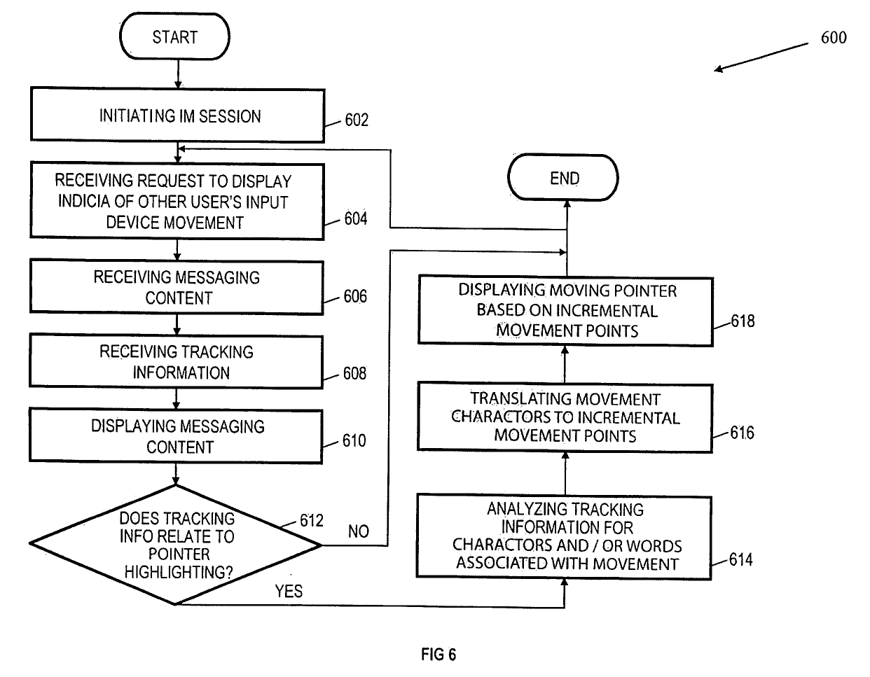

The input device movement translator 308 may receive tracking information from another client computer system 102 and/or IM client 108 to translate that into display commands for displaying an equivalent movement to a user of the recipient client computer system 102. As such, the input device movement translator 308 need only execute on a client computer system 102 on which equivalent movements based on tracking information from another client computer system 102 are displayed. In contrast, the input device tracking module 306 need only be located on a client computer system 102 that is the source of tracking information, and a particular client computer system 102 may include either or both of the input device tracking module 306 and the input device movement translator 308. As will be described subsequently in relation to FIGS. 5 and 6, the input device movement translator 308 may translate any received tracking information into equivalent movement commands for display to a user. A user with a client computer system 102 equipped with an input device movement translator 308 may thus view movements such as highlighting or pointer movements from another user in their instant messaging window.

While the components of the client computer system 102 are depicted as separate modules, their functions may be combined or split in any fashion. For example, the IM client 108 may perform some or all of the functions of the input device tracking module 306 or input device movement translator 308. In this example, the IM client 108 may have input device movement capability built-in to its functionality.

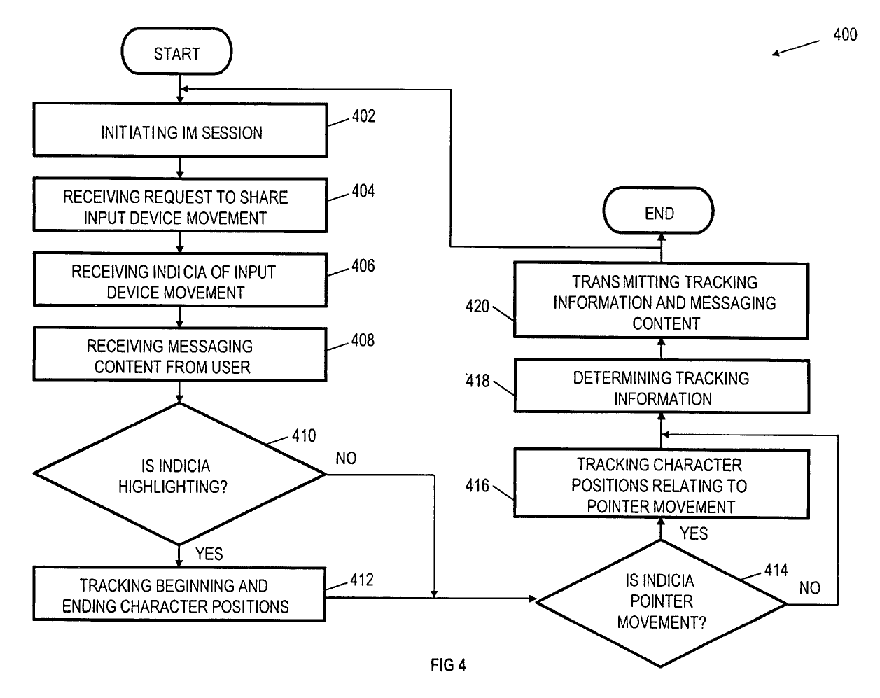

FIG. 4 depicts an example of a flow chart 400 for determining and transmitting tracking information relating to input device movement according to one embodiment. The method of flow chart 400 may be performed, in one embodiment, by a client computer system 102 with an input device tracking module 306. Flow chart 400 begins with element 402, where an IM client 108 may initiate an instant messaging session to start an instant messaging ‘conversation’. The IM client 108 may, in one embodiment, initiate the session when a user of the IM client 108 either selects a contact with whom they desire to start a session or affirmatively responds to a request for a session from another user.

At element 404, the input device tracking module 306 may optionally receive a request to share input device movement with another user who is party to the instant messaging conversation. A user may express her desire to share input device movement with another user in any fashion, such as by actuating a mouse button, holding down a key on a keyboard 222, or voice command. Alternatively, the input device tracking module 306 may use a different methodology to determine that it should track input device movement or automatically track such movement. The input device tracking module 306 may receive an indicia of the input device movement from the user input module 304 at element 406. Similarly, the IM client 108 may also receive any messaging content from the user input module 304 at element 408. Messaging content may be text or other content (e.g., image files, sounds files, etc.) the user inputs as part of an instant message.

After receiving request to share input device movement at element 404 and the indicia of input device movement at element 406, the input device tracking module 306 determines how to track the input device movement. At decision block 410, the input device tracking module 306 may determine whether the received indicia relates to highlighting of text. If the indicia does relate to text highlighting, the input device tracking module 306 may track the beginning and ending character positions of the highlighted text at element 412. The input device tracking module 306 may also track other emphasis from the user, such as if they requested increased emphasis for the highlighting such as a different color, font, size, boldface, flashing, etc. For example, a user could hold down a particular key while highlighting text to add extra emphasis to that highlighting.

At decision block 414, the input device tracking module 306 may determine whether the received indicia relates to pointer movement. If the received indicia does relate to pointer movement, the method of flow chart 400 continues to element 416, where the input device tracking module 306 may track character positions relating to the mouse movement. In one embodiment, the input device tracking module 306 may track the characters or words in the instant messaging window that are closest to the beginning and end of each mouse movement. In further embodiments, the input device tracking module 306 may also track interim characters or words that the pointer passes over or near during its movement. In this embodiment, the actual path of the pointer movement may be more precisely tracked. In further embodiments, the time the pointer requires to move from one point to another may also be tracked so that the input device tracking module 306 may determine a velocity of the movement. In some cases, the rapidity of the mouse movement may be important to a user in communicating information, such as when a user emphasizes text by quickly moving the pointer back and forth over it.

One skilled in the art will recognize that the input device tracking module 306 may use any suitable methodology or combination of methodologies for tracking input device movement in addition to those described in relation to elements 412 and 416. After the input device tracking module 306 has tracked the input device movement, it may next determine the tracking information based on the input device movement at element 418. Tracking information may be any information used to identify tracked input device movement, such as beginning or ending characters or words, times or velocity for movement, the type on input, the identity of the input device, the identity of a button selected, highlighting or ghost pointer emphasis, etc. The input device tracking module 306 may next transmit the tracking information to the IM client 108 or communications module 302 for transmittal, after which the method of flow chart 400 terminates. The tracking information may be transmitted separately from any messaging content, may be cached, or may be transmitted in a package with messaging content.

FIG. 5 depicts an example of a flow chart 500 for receiving highlighting tracking information from another client computer system 102 and displaying an equivalent movement to a user according to one embodiment. The method of flow chart 500 may be performed, in one embodiment, by a client computer system 102 with an input device movement translator 308. Flow chart 500 begins with element 502, where an IM client 108 may initiate an instant messaging session to start an instant messaging ‘conversation’ with another IM client 108 on a client computer system 102 with an input device tracking module 306. The IM client 108 may, in one embodiment, initiate the session when a user of the IM client 108 either selects a contact with whom they desire to start a session or affirmatively respond to a request for an IM session from another user.

The input device movement translator 308 may, at optional element 504, receive a request to display indicia of the other user's input device movement. In one embodiment, a user may configure their IM client 108 so as to allow display of other user's input device movement on their own display. In some embodiments, the user may limit such display to a particular user or group of users that they trust. In other embodiments, element 504 is not necessary and input device movement is automatically displayed. In other embodiments, the input device movement translator 308 may query the user whether input device movement should be displayed upon receipt of tracking information at element 508 below. The method of flow chart 500 may then continue to element 506, where the IM client 108 may optionally receive messaging content from the sending client computer system 102 whose session was initiated at element 502. Similarly, the input device movement translator 308 may receive tracking information (through the communications module 302) from the sending client computer system 102 at element 508. As described previously, the tracking information and messaging content may be received as part of the same package, separately, or in any other fashion. The IM client 108 may display any received messaging content at element 510.

After receiving the tracking information, the input device movement translator 308 may next determine at decision block 512 whether the tracking information relates to highlighting of text by analyzing the tracking information. If the tracking information does not relate to highlighting, the method either terminates, returns to element 504 for continued processing, or optionally performs all or part of other methods (such as that of FIG. 6) for handling other types of input device movement besides highlighting. If the tracking information does relate to highlighting, the method of flow chart 500 continues to element 514, where the input device movement translator 308 may analyze the tracking information for beginning and ending characters associated with the highlighted text. The input device movement translator 308 may also analyze the tracking information for other aspects of the highlighting, such as an indication of increased emphasis (e.g., different color, font, size, boldface, etc.). The input device movement translator 308 may work with the IM client 108 to display the highlighting (with any requested emphasis added) from the beginning character to the end character at element 516, after which the method either terminates or returns to element 504 for further processing. The equivalent movement in the IM Window for the recipient user may be simply the highlighting of the appropriate text in that window. In this fashion, the recipient user may see text highlighted by the sending user, allowing the users to communicate highlighting information via an instant messaging window.

In one embodiment, the beginning and ending characters may be measured from the last character in the instant messaging window. This may increase accuracy in situations where the windows of different users are displaying different amounts of history (and thus text).

By counting from the end of the text, a more precise measure of the highlighted text may be achieved. In one example, if the sending user highlighted from the 100^{th} character to the 110^{th} character in their own window, the input device movement translator 308 may generate an equivalent movement from the 100^{th} to the 110^{th} characters regardless of how large the windows were, how much history was displayed, etc.

FIG. 6 depicts an example of a flow chart 600 for receiving pointer movement tracking information from another client computer system 102 and displaying an equivalent movement to a user according to one embodiment. The method of flow chart 600 may be performed, in one embodiment, by a client computer system 102 with an input device movement translator 308. Flow chart 600 begins with element 602, 604, 606, 608, and 610, which may be substantially similar to elements 502, 504, 506, 508, and 510, respectively, of FIG. 5, and the discussion will not be repeated in the interest of brevity. The received tracking information at element 608 may include one or more characters or words associated with the beginning or end of an input device movement, times or velocity for any input device movement, interim characters or words associated with input device movement, or other information.

After receiving the tracking information, the input device movement translator 308 may next determine at decision block 612 whether the tracking information relates to pointer movement of text by analyzing the received tracking information. If the tracking information does not relate to pointer movement, the method either terminates, returns to element 604 for continued processing, or optionally performs all or part of other methods (such as that of FIG. 5) for handling other types of input device movement besides mouse movement. If the tracking information does relate to pointer movement, the method of flow chart 600 continues to element 614, where the input device movement translator 308 may analyze the tracking information for characters and/or words associated with the pointer movement. Characters and/or words associated with the pointer movement may include beginning, end, or interim characters and/or words. The input device movement translator 308 may also analyze the tracking information for other aspects of the mouse movement, such as the velocity of movement or a more precise movement path (with interim points).

After analyzing the tracking information, the input device movement translator 308 may at element 616 translate the tracking information into one or more incremental movement points associated with the recipient instant messaging window. In one embodiment, the incremental movement points may include only the beginning and end points of a movement. In other embodiments, the incremental movement points may include one or more points in between the beginning and ending points. The input device movement translator 308 may then work with the IM client 108 to display a moving pointer based on the incremental moving points at element 618, after which the method either terminates or returns to element 604 for further processing. The pointer may, in some embodiments, be a ‘ghost’ pointer that is partially faded so the user does not confuse it with their own pointer. Other types and configurations of the pointer may be used, including different shapes (e.g., arrows), colors, sizes, intensities, etc. In an alternative embodiment, the pointer may be emphasized similarly to the highlighting of FIG. 5, such as by making the ghost pointer flashing, increasing in size, etc.

In this fashion, the recipient user may see equivalent movement via their instant messaging window to any mouse or pointer movement by the sending user. The input device movement translator 308 may accomplish this by utilizing the start and end characters' positions (measuring backwards from the end of the window) of the recipient window to match the same characters in the sending IM window. In one example, if a sending user moved their pointer over the 5^{th} word and moved it up three lines and to the right to the 60^{th} word, the input device movement translator 308 can recreate that motion by moving a ghost pointer from the 5^{th} word to the 60^{th} word in its window, even if those words are located in different places within the window. The input device movement translator 308, by relying on character or word locations instead of geometric position, can thus accommodate differences in window sizes, text sizes, amounts of history, etc., between the sender and recipient window. If the recipient user's instant messaging window is much narrower than the sending user's window, for example, an equivalent movement may be steeper on the recipient's window (while still starting and ending on the same characters or words). In one embodiment, if the sender and recipient user's windows are different sizes and the equivalent movement would result in scrolling of the recipient window, the input device movement translator 308 may either automatically scroll the IM window or allow the pointer to ‘bump’ the edge of the IM window. An administrator or user may, in some embodiments, configure how the input device movement translator 308 handles such a situation.

The input device movement translator 308 may also provide additional fidelity in recreating input device movement. In one example, the input device movement translator 208 may take advantage of tracking information that contains interim points for the movement, allowing for the recreation of more sophisticated gestures than simple point-to-point movements (e.g., circling, back and forth motions, etc). In another example, the input device movement translator 208 may take into account a movement velocity, displaying the equivalent movement at a velocity based on the initial movement. A sender who quickly moves their mouse from point to point will, in this example, generate a quicker movement in the recipient's window.

In general, the routines executed to implement the embodiments of the invention, may be part of an operating system or a specific application, component, program, module, object, or sequence of instructions. The computer program of the present invention typically is comprised of a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

It will be apparent to those skilled in the art having the benefit of this disclosure that the present invention contemplates methods, systems, and media for sharing input device movement information in an instant messaging system. It is understood that the form of the invention shown and described in the detailed description and the drawings are to be taken merely as examples. It is intended that the following claims be interpreted broadly to embrace all the variations of the example embodiments disclosed.

What is claimed is:

1. A method for displaying input device movement information from a user of an instant messaging system, the method comprising:
receiving tracking information by a first client computer system, the tracking information relating to input device movement associated with a second client computer system;
determining an equivalent movement by the first client computer system, the equivalent displayed movement being based on the received tracking information; and
displaying the equivalent movement by the first client computer system.

2. The method of claim 1, further comprising receiving a request to display indicia of input device movement associated with the second client computer system.

3. The method of claim 1, wherein the tracking information comprises one or more of a beginning point of highlighting, an ending point of highlighting, a beginning point of pointer movement, an ending point of pointer movement, an indication of velocity, or an indication of emphasis.

4. The method of claim 1, wherein determining the equivalent movement by the first client computer system comprises analyzing the tracking information for a character associated with the beginning of highlighting and for a character associated with the end of highlighting.

5. The method of claim 1, wherein determining the equivalent movement by the first client computer system comprises analyzing the tracking information for a word associated with the beginning of highlighting and for a word associated with the end of highlighting.

6. The method of claim 1, wherein determining the equivalent movement by the first client computer system comprises:
analyzing the tracking information for a beginning point and an ending point for pointer movement; and
translating the beginning point and ending point to one or more incremental movement points.

7. The method of claim 1, wherein displaying the equivalent movement by the first client computer system comprises displaying highlighting from a beginning character to an ending character.

8. The method of claim 1, wherein displaying the equivalent movement by the first client computer system comprises displaying a ghost pointer moving from a beginning point to an ending point.

9. A machine-accessible medium containing instructions effective, when executing in a data processing system, to cause said data processing system to perform operations comprising:
receiving tracking information by a first client computer system, the tracking information relating to input device movement associated with a second client computer system;
determining an equivalent movement by the first client computer system, the equivalent displayed movement being based on the received tracking information, and
displaying the equivalent movement by the first client computer system.

10. The machine-accessible medium of claim 9, further comprising receiving a request to display indicia of input device movement associated with the second client computer system.

11. The machine-accessible medium of claim 9, wherein the tracking information comprises one or more of a beginning point of highlighting, an ending point of highlighting, a beginning point of pointer movement, an ending point of pointer movement, an indication of velocity, or an indication of emphasis.

12. The machine-accessible medium of claim 9, wherein determining the equivalent movement by the first client computer system comprises analyzing the tracking information for a character associated with the beginning of highlighting and for a character associated with the end of highlighting.

13. The machine-accessible medium of claim 9, wherein determining the equivalent movement by the first client computer system comprises analyzing the tracking information for a word associated with the beginning of highlighting and for a word associated with the end of highlighting.

14. The machine-accessible medium of claim 9, wherein determining the equivalent movement by the first client computer system comprises:
analyzing the tracking information for a beginning point and an ending point for pointer movement; and
translating the beginning point and ending point to one or more incremental movement points.

15. The machine-accessible medium of claim 9, wherein displaying the equivalent movement by the first client computer system comprises displaying highlighting from a beginning character to an ending character.

16. The machine-accessible medium of claim 9, wherein displaying the equivalent movement by the first client computer system comprises displaying a ghost pointer moving from a beginning point to an ending point.

17. A client computer system of an instant messaging system, the system comprising:
an instant messaging client to initiate an instant messaging session with a second client computer system, the instant messaging client being adapted to send and receive instant messages;
a communications module in communication with the instant messaging client, the communications module being adapted to receive tracking information over a network, the tracking information relating to input device movement associated with the second client computer system; and
an input device movement translator to translate the received tracking information to an equivalent movement for display to a user.

18. The system of claim 17, further comprising an input device tracking module to track movement of a user input device and to determine tracking information, wherein the communications module is adapted to transmit the tracking information to a different client computer system.

19. The system of claim 17, wherein the communications module is adapted to communicate directly with the different client computer system over the network.

20. The system of claim 17, wherein the communications module is adapted to communicate with the different client computer system through an instant messaging server.
